(19) United States
(12) Patent Application Publication
(10) Pub. No.: US 2014/0181112 A1
(43) Pub. Date: Jun. 26, 2014

(54) CONTROL DEVICE AND FILE DISTRIBUTION METHOD

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: CHUNG-I LEE, New Taipei (TW); DE-YI XIE, Shenzhen (CN); SHUAI-JUN TAO, Shenzhen (CN); ZHI-QIANG YI, Shenzhen (CN); JUN-CHAO YAO, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/108,404

(22) Filed: Dec. 17, 2013

(30) Foreign Application Priority Data
Dec. 26, 2012 (CN) 1212105712569

(51) Int. Cl. G06F 17/30

(52) U.S. Cl. CPC G06F 17/30194
USPC 707/740

(57) ABSTRACT

In a file distribution method using a control server in connection to file servers, file categories are preset and the file servers are classified into the file categories. When a file is received, a file category of the received file is determined, and the received file is distributed to a target file server according to the determined file category. The method determines a load value of each of the file servers according to a number of files to be processed in each of the file servers. A specified file server whose load value is equal to a threshold value is determined, and an overload file server having a greatest load value is determined. The method distributes files to be processed in the overload file server to the specified file servers according to a predetermined percentage.

### BACKGROUND

1. Technical Field

Embodiments of the present disclosure relate to file management technology, and particularly to a control device and a file distribution method using the control device.

2. Description of Related Art

Multiple file servers can be used to store and process many files. It is important to distribute the files to the multiple file servers for ensuring a processing efficiency of the files and load balancing of the multiple file servers. Accordingly, a method for optimizing resource use, maximizing throughput, minimizing response time, and avoiding overload of any one of the file severs is desired.

### BRIEF DESCRIPTION OF THE DRAWINGS

FIG. 1 is a block diagram of one embodiment of a control server in connection to a plurality of file servers.

FIG. 2 is a block diagram of one embodiment of the control server including a file distribution system.

FIG. 3 is a flowchart of one embodiment of a file distribution method using the file distribution system.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

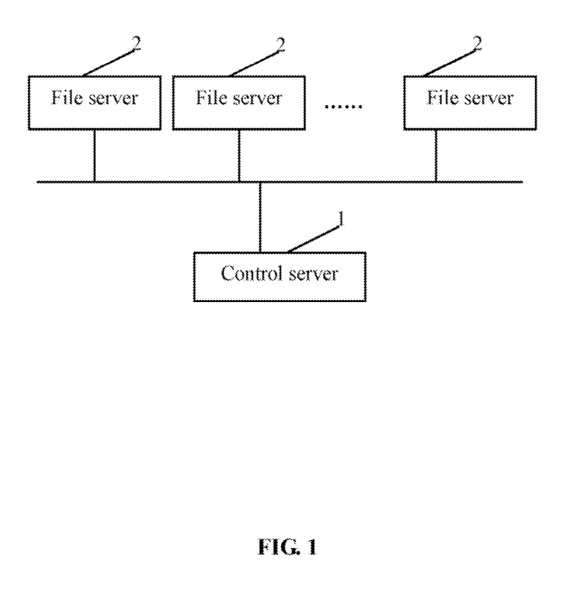

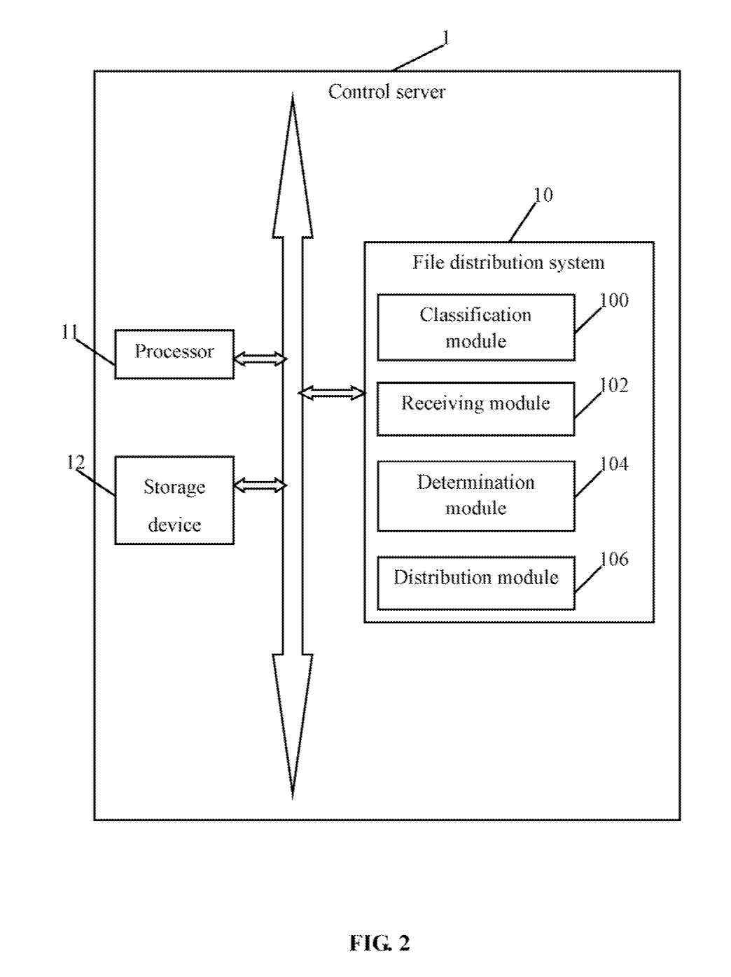

FIG. 1 is a block diagram of one embodiment of a control server 1 in connection to a plurality of file servers 2. In some embodiments, the control server 1 and the file servers 2 may be desktop computers, notebook computers, or any other computing devices. The control server 1 includes a file distribution system 10 as shown in FIG. 2, is used to classify multiple kinds of files, and distribute the files to the file servers 2. The file servers 2 are used to process the distributed files, such as parsing file contents, generating parsed data, for example. The file servers 2 may have various kinds of file processing software to process different kinds of files, such as patent documents and Office actions from different Patent Offices. In other embodiments, the file servers 2 may invoke or download desired file processing software from the control server 1 if needed.

In some embodiments, the control server 1 can be an independent control device, or designated from the file servers 2, that is, the control server 1 also can be a file server.

FIG. 2 is a block diagram of one embodiment of the control server 1 including the file distribution system 10. The control server 1 further includes at least one processor 11 and a storage device 12. FIG. 2 illustrates only one example of the control server 1 that may include more or fewer components than illustrated, or have a different configuration of the various components.

The at least one processor 11 is used to execute the file distribution system 10 and other applications installed in the control server 1, such as an operating system of the control server 1. The storage devices 12 store one or more programs, such as the operating system and applications of the control server 1. In some embodiments, the storage device 12 may be a hard disk, or an external storage card, such as a memory stick, a smart media card, a compact flash card, a secure digital card, or any other type of memory storage device.

The file distribution system 10 may classify files received by the control server 1 into preset file categories, distribute the files to different file servers 2, and balance loads of the file servers 2 by adjusting a number of files to be processed in each of the file servers 2.

The file distribution system 10 may include computerized instructions in the form of one or more programs that are executed by the at least one processor 11 and stored in one or more of the storage devices 12. In one embodiment, the file distribution system 10 may include one or more modules, for example, a classification module 100, a receiving module 102, a determination module 104, and a distribution module 106. In general, the word “module,” as used herein, refers to logic embodied in hardware or firmware, or to a collection of software instructions, written in a programming language, such as, JAVA, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

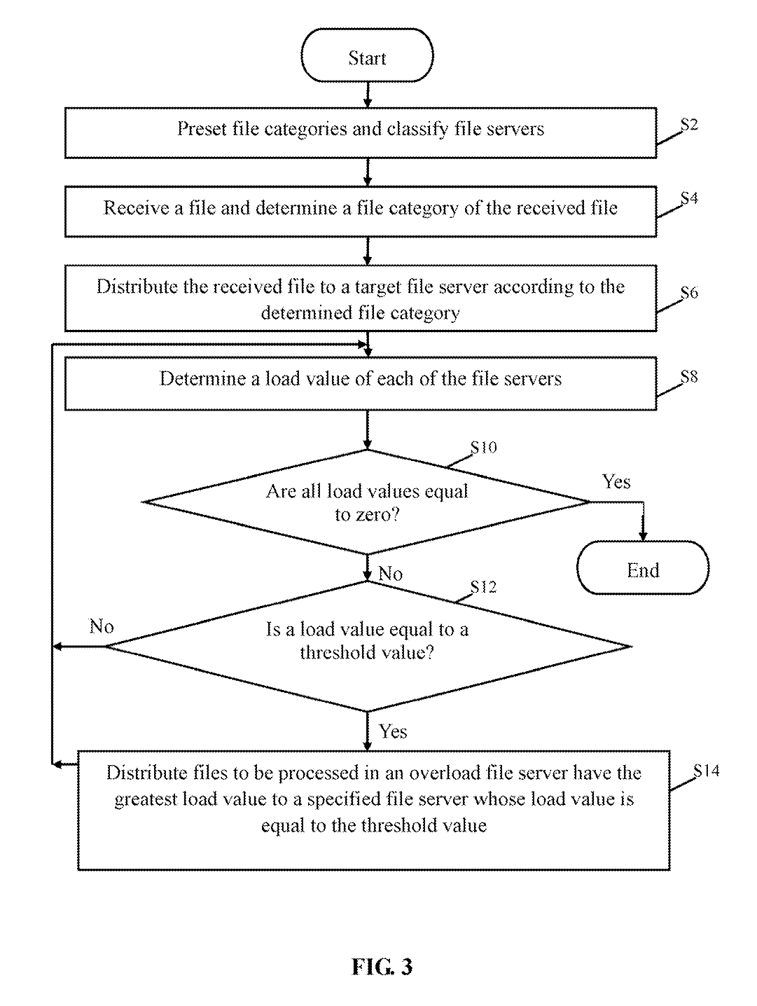

FIG. 3 is a flowchart of one embodiment of a file distribution method using the file distribution system 10. Depending on the embodiment, additional steps may be added, others removed, and the ordering of the steps may be changed.

In step S2, the classification module 100 presets a plurality of file categories, and classifies the file servers 2 according to the file categories.

In some embodiments, as mentioned above, the files may be patent documents, Office actions sent from the Patent and Trademark Office in different countries, thus, the classification module 100 may preset the file categories according to different countries, such as the United States, or China, for example. In other embodiments, the classification module 100 may preset the file categories according to attributes, formats, or contents of the files.

The file servers 2 are classified into the file categories to process different kinds of files.

In step S4, the receiving module 102 receives a file to be processed, determines a file category of the received file. The receiving module 102 may receive the file from different offices, organizations, or enterprises through the Internet or any other communication network, or receive the file according to uploading operations of one or more users through an intranet.

In step S6, the receiving module 102 distributes the received file to a target file server 2 according to the determined file category.

In step S8, the determination module 104 determines a load value of each of the file servers 2 according to a number of files to be processed in each of the file servers 2. In some embodiments, the load value of each file server 2 is equal to the number of files in each file server 2. For example, a file server A has 100 files to be processed, that is, a load value of the file server A is 100.

In step S10, the determination module 104 determines whether all load values of the file servers 2 are equal to zero. When all load values of the file servers 2 are equal to zero, the determination module 104 determines that all files have been processed, and the procedure ends. When there is one or more load values of one or more file servers 2 greater than zero, step S12 is implemented.

In step S12, the determination module 104 determines whether there is a load value being equal to a predetermined threshold value.

In some embodiments, the predetermined threshold value is used to determine whether a file server 2 has enough resource to process files in the other file severs 2. For example, the predetermined threshold value can be zero or any other value preset according to user requirements. When there is one load value being equal to the predetermined threshold value, the determination module 104 determines that a file server 2 corresponding to the one load value has enough resources to process files in the other file servers 2.

When there is a load value being equal to the predetermined threshold value, step S14 is implemented. When there is no load value being equal to the predetermined threshold value, the procedure returns to step S8.

In step S14, the determination module 104 determines a specified file server 2 whose load value is equal to the predetermined threshold value, determines an overload file server 2 having a greatest load value, and the distribution module 106 distributes files to be processed in the overload file server 2 to the specified file server 2 according to a predetermined percentage.

For example, the predetermined percentage may be 50 percent. That is, an average is taken of the files to be processed in the overload file server 2. In another example, the predetermined percentage may be any other value, and may be modified by the user.

In some embodiments, the file distribution method may be executed in file servers 2 belonging to a same file category. In other embodiments, the file distribution method may be executed among all the file servers 2 no matter which file categories that the overload file server 2 and the specified file server(s) 2 belong.

In detail, the classification module 100 may preset a category code for each file category, and assign the category code to one or more file processing software that process files in a corresponding file category. The receiving module 102 inserts a category code into a file property of the received file. The category code is used to identify the file category of the received file, and determine a corresponding file processing software to process the received file. For example, the category code may be “CN”, “US”, “EP”. When the files distributed from the overload file server 2 to the specified file server 2 are in a different file category with the specified file server 2, the specified file server 2 may determine a file category of the distributed files and invoke file processing software corresponding to the file category to process the distributed file.

In other embodiments, when there is more than one load values being equal to the predetermined threshold value, the determination module 104 determines more than one specified file servers 2 correspondingly. The distribution module 106 may distribute the overload file server 2 having the greatest load value to one of the specified file servers. After the distribution, another file server 2 currently having the greatest load value is determined to be the updated overload file server 2, and the distribution module 106 distributes files to be processed in the updated overload file server 2 to the another specified file server 2 until all of the specified file servers 2 have been distributed files to be processed.

In other embodiments, the classification module 100 may preset load levels for the file servers 2 according to numbers of the files to be processed in the file servers 2, and determines a load level of each file server 2 according to the load value of each file server 2. The load levels may include, but are not limited to a highest-level, a high-level, a mid-level, a low-level, and a lowest-level. For example, when a number of files in a file server 2 is more than a first preset number (e.g., 1000), the file server 2 is classified into the highest-level. When a number of files in a file server 2 is within a preset range of [a second preset number, a first preset number] (e.g., [700, 1000]), the file server 2 is classified into the high-level. A range of the mid-level may be [a third preset number, a fourth preset number], such as [400, 699]. A range of the low-level may be [a fifth preset number, a sixth preset number], such as [1, 400], and a seventh preset number (e.g., 0) is used to determined the lowest-level.

Furthermore, the distribution module 106 balances loads of the file servers 2 in different load levels by distributing files in the file servers in higher load levels and the file servers in lower load levels according to an average distribution rule.

It should be emphasized that the above-described embodiments of the present disclosure, particularly, any embodiments, are merely possible examples of implementations, set forth for a clear understanding of the principles of the disclosure.

Many variations and modifications may be made to the above-described embodiment(s) of the disclosure without departing substantially from the spirit and principles of the disclosure. All such modifications and variations are intended to be included herein within the scope of this disclosure and the present disclosure is protected by the following claims.

What is claimed is:

1. A computer-implemented method for distributing files using a control server, the control server in connection to file servers, the method comprising:
presetting file categories, and classifying the file servers according to the file categories;
receiving a file, determining a file category of the received file, and distributing the received file to a target file server according to the determined file category;
determining a load value of each of the file servers according to a number of files to be processed in each of the file servers;
determining a specified file server whose load value is equal to a threshold value;
determining an overload file server having a greatest load value; and
distributing files to be processed in the overload file server to the specified file servers according to a predetermined percentage.

2. The method according to claim 1, further comprising:
presetting load levels for the file servers; and
determining a load level of each of the file servers according to the load value of each of the file servers.

3. The method according to claim 2, further comprising:
balancing loads of the file servers in different load levels by distributing files in the file servers in higher load levels and the file servers in lower load levels according to an average distribution rule.

4. The method according to claim 1, further comprising:
determining that all files have been processed when all load values of the file servers are equal to zero.

5. The method according to claim 1, further comprising:
presetting a category code for each file category, and assigning the category code to one or more file processing software that process files in a corresponding file category;
inserting a category code into a file property of the received file; and
invoking corresponding file processing software to process the received file.

6. The method according to claim 1, wherein the files to be processed are patent documents and Office actions received from one or more Patent Offices, and the file categories are preset according to the one or more Patent Offices.

7. A control server in connection to file servers, the control server comprising:
at least one processor; and
a plurality of storage devices storing a plurality of instructions, which when executed by the processor, causes the at least one processor to:
preset file categories, and classifying the file servers according to the file categories;
receive a file, determining a file category of the received file, and distribute the received file to a target file server according to the determined file category;
determine a load value of each of the file servers according to a number of files to be processed in each of the file servers;
determine a specified file server whose load value is equal to a threshold value;
determine an overload file server having a greatest load value; and
distribute files to be processed in the overload file server to the specified file servers according to a predetermined percentage.

8. The electronic device according to claim 7, wherein the at least one processor further:
presets load levels for the file servers; and
determines a load level of each of the file servers according to the load value of each of the file servers.

9. The electronic device according to claim 8, wherein the at least one processor further balances loads of the file servers in different load levels by distributing files in the file servers in higher load levels and the file servers in lower load levels according to an average distribution rule.

10. The electronic device according to claim 9, wherein the at least one processor further determines that all files have been processed when all load values of the file servers are equal to zero.

11. The electronic device according to claim 7, wherein the at least one processor further:
presets a category code for each file category, and assigns the category code to one or more file processing software that process files in a corresponding file category;
inserts a category code into a file property of the received file; and
invokes corresponding file processing software to process the received file.

12. The electronic device according to claim 7, wherein the files to be processed are patent documents and Office actions received from one or more Patent Offices, and the file categories are preset according to the one or more Patent Offices.

13. A non-transitory storage medium having stored thereon instructions that, when executed by a processor of an electronic device, causes the electronic device to perform a method for re distributing files using a control server, the control server in connection to file servers, the method comprising:
presetting file categories, and classifying the file servers according to the file categories;
receiving a file, determining a file category of the received file, and distributing the received file to a target file server according to the determined file category;
determining a load value of each of the file servers according to a number of files to be processed in each of the file servers;
determining a specified file server whose load value is equal to a threshold value;
determining an overload file server having a greatest load value; and
distributing files to be processed in the overload file server to the specified file servers according to a predetermined percentage.

14. The non-transitory storage medium according to claim 13, wherein the method further comprises:
presetting load levels for the file servers; and
determining a load level of each of the file servers according to the load value of each of the file servers.

15. The non-transitory storage medium according to claim 14, wherein the method further comprises:
balancing loads of the file servers in different load levels by distributing files in the file servers in higher load levels and the file servers in lower load levels according to an average distribution rule.

16. The non-transitory storage medium according to claim 13, wherein the method further comprises:
determining that all files have been processed when all load values of the file servers are equal to zero.

17. The non-transitory storage medium according to claim 13, wherein the method further comprises:
presetting a category code for each file category, and assigning the category code to one or more file processing software that process files in a corresponding file category;
inserting a category code into a file property of the received file; and
invoking corresponding file processing software to process the received file.

18. The non-transitory storage medium according to claim 13, wherein the files to be processed are patent documents and Office actions received from one or more Patent Offices, and the file categories are preset according to the one or more Patent Offices.
